(19) United States
(12) Patent Application Publication
(10) Pub. No.: US 2023/0076190 A1
(43) Pub. Date: Mar. 9, 2023

(54) Vehicle Having a Bus Line

(71) Applicant: Bayerische Motoren Werke Aktiengesellschaft, Muenchen (DE)

(72) Inventors: Joachim Froeschl, Herrsching (DE); Michael Kaindl, Ergoldsbach (DE); Helmut Kellermann, Oberschleissheim (DE)

(21) Appl. No.: 17/794,679

(22) PCT Filed: Nov. 20, 2020
(86) PCT No.: PCT/DE2020/100982

§ 371 Date: Jul. 22, 2022

(30) Foreign Application Priority Data
Jan. 29, 2020 (DE) 10 2020 102 188.7

(51) Int. Cl. H04L 12/40; G08C 17/06; H04B 5/00

(52) U.S. Cl. CPC H04L 12/40006; G08C 17/06; H04B 5/0031; H04L 2012/40215

(57) ABSTRACT

A vehicle including a bus and an electronic module. The bus line has at least two signal lines and a bus line coupling element. The electronic module has at least one transceiver component having a transceiver coupling element. The transceiver coupling element can be coupled to the bus line coupling element in order to be able to transmit data into the bus line or receive data from the bus line in a coupled state. The bus line coupling element and the transceiver coupling element are configured for contact-free coupling.

The present application is the U.S. national phase of PCT Application PCT/DE2020/100982 filed on Nov. 20, 2020, which claims priority of German patent application No. 102020102188.7 filed on Jan. 29, 2020, which is incorporated herein by reference in its entirety.

### TECHNICAL FIELD

The present disclosure relates to a vehicle having a bus line and an electronic module, wherein the electronic module can transmit data into the bus line or receive data from the bus line.

### BACKGROUND

Modern vehicles comprise a plurality of control units for a plurality of vehicle functions. The individual control units must be supplied with electrical energy from an on-board vehicle network. The computers are also integrated into a communication network in order to enable the exchange of data between different control units of the vehicle and/or sensors and/or actuators as communication partners or electronic components. Data is exchanged between the various electronic components via one or more bus lines. Each of the electronic components must be coupled to the bus line in order to transmit data into the bus line or to receive data from the bus line. For this purpose, each of the electronic components has a transceiver component that enables the sending and receiving of data. Depending on the particular bus line, the coupling between the bus line and the electronic component is either wired or optical by connecting a connector element of the bus line to a corresponding connector element of the electronic component. Due to the large number of electronic components, a large number of connections have to be made during the production of the vehicle. This leads to substantial integration effort, high costs and a high demand for installation space, both on or in the electronic component and in the surroundings, in order to be able to realize the plug connection during assembly.

One object of the disclosure is to specify a vehicle in which a more efficient coupling of electronic components to a bus line is made possible.

### SUMMARY

This object, as well as others, are achieved by means of a vehicle according to the features of disclosed herein.

In one embodiment, a vehicle includes a bus line having at least two signal lines and a bus line coupling element. Vehicles include road vehicles, such as passenger cars, trucks, tractors, motorcycles, rail-bound vehicles, such as trains or trams, aircraft (including spacecraft), and ships. The vehicle also comprises an electronic module that comprises at least one transceiver component having a transceiver coupling element, wherein the transceiver coupling element can be coupled to the bus line coupling element in order to be able to transmit data into the bus line or receive data from the bus line in the coupled state. An electronic module is understood to mean any electronic component of a vehicle, including control units, sensors, actuators, etc., that exchanges data with other electronic components via a bus line in a vehicle and transmits data into the bus line or receives data from the bus line for the purpose. A transceiver component is understood to mean a transceiver unit, i.e. a communication component, which is designed to transmit data provided by a computing unit of the electronic component or to receive data and to transmit this data to another computing unit for further processing.

The vehicle is characterized in that the bus line coupling element and the transceiver coupling element are designed for contact-free coupling. In this description, a contact-free coupling is understood to mean a galvanically isolated and non-optical, contactless coupling, which does not require that the respective components of the bus line coupling element and the transceiver coupling element be in direct (conductive) contact with each other. In particular, the components of the bus line coupling element and the transceiver coupling element required for signal transmission can be arranged a distance apart from each other.

A direct, non-optical, contact-free or contactless connection of the bus line to the transceiver component of the electronic module is therefore proposed. This gives rise to the fundamental possibility of being able to dispense with previously required connector elements, so that the dimensions, in particular of the transceiver coupling element, can be considerably reduced compared to previous connectors. This can also reduce the installation size of the electronic module. The direct, non-optical, contact-free coupling enables minimal mechanical tolerances between the transceiver component and the bus line coupling element due to a direct mounting. Due to the absence of electrical contacts for an electrical plug connection, there is no need for finishing of the contact parts in the region of the coupling elements, which can significantly reduce the costs of connecting the bus line to the electronic module. Problems associated with aging of electrical contacts are also eliminated. Due to the possibility of making the coupling elements smaller than previous contacting means, it becomes possible to implement simpler shielding measures, which can reduce EMC problems.

The use of direct, non-optical, contact-free coupling is particularly advantageous when transmitting data with higher frequencies, in particular above 1 MHz.

According to a refinement, the bus line coupling element and the transceiver coupling element each have coupling parts adapted in size and geometry per signal line, which are arranged facing one another and aligned towards one another in the coupled state. The size and geometry of each coupling part can in principle be designed as required. In particular, the shape and size must be designed to match the characteristic impedance selected for the bus line and to minimize reflections. The coupling parts can have the shape of a polygon, a rectangle, a square, but also any arbitrary irregular shape.

According to a first alternative, the bus line coupling element and the transceiver coupling element are designed for capacitive coupling, wherein the coupling parts of the bus line coupling element and the associated coupling parts of the transceiver coupling element are coupling surfaces that in the coupled state are arranged facing each other, separated by a dielectric. In the capacitive coupling, the coupling parts, which are matched to each other in size and geometry, are positioned one above the other and thus aligned with respect to each other in order to ensure a good coupling coefficient. In an alternative embodiment, the bus line coupling element and the transceiver coupling element are designed for inductive coupling, wherein the coupling parts of the bus line coupling element and the associated coupling parts of the transceiver coupling element are designed as flat coils that are arranged facing each other in the coupled state. The flat coils are thus positioned on top of one another and thus aligned with respect to each other in order to enable the inductive coupling. The formation of flat coils for inductive coupling can be implemented, for example, by means of a meandering shape of the respective signal lines in the region of the coupling elements, wherein the meandering shape of each respective signal line then forms the coupling part.

It is understood by a person skilled in the art that each of the at least two signal lines of a bus line in the region of the bus line coupling element has a respective coupling part, either as a surface for capacitive coupling or as a flat coil for inductive coupling. The coupling parts can be arranged at the same height in the extension direction of the at least two signal lines or offset with respect to each other in the longitudinal direction, depending on the prevailing space conditions.

A further practical embodiment provides that the coupling parts of the bus line coupling element are integral components of the respective signal lines. In other words, the coupling parts can consist of the material of the signal lines. If the signal lines are made of copper, for example, the coupling parts can also be made of copper. Other common materials for signal lines and thus also for the coupling parts are aluminum, gold, or conductive alloys of these. In another embodiment, it is also conceivable that the contact parts consist of a different material from the material of the signal lines and are subsequently attached to the signal lines, for example.

A further practical embodiment provides that the coupling parts of the bus line coupling element and/or the coupling parts of the transceiver coupling element are surrounded by an insulation layer. In the case of a capacitive coupling, the insulation layer forms a dielectric between the coupling parts of the bus line coupling element and the transceiver coupling element. For this reason, it is advantageous if the insulation layer has a high dielectric constant. In principle, the material for insulating the bus line or the respective signal lines can be used as insulation material for this purpose. If a particularly high dielectric constant is to be achieved in the region of the coupling parts, then, for example, glass, Teflon or BaTiO₃ can be used as the insulation material for the coupling parts and as the insulation layer.

A further advantageous embodiment provides that the bus line is arranged on or in a carrier. In particular, the carrier can be a busbar, which is configured in the vehicle, for example, to provide a power supply for a plurality of electronic modules. Such a design variant is described, for example, in DE 10 2015 201 442 A1 by the applicant.

In accordance with another practical embodiment, the bus line is integrated, at least in some sections, into a cable harness of the vehicle or is part of a cable harness of the vehicle. In accordance with this design variant, it is not necessary to provide conventional plug connector elements on the bus line, but the bus line coupling elements can instead be connected to the transceiver coupling element by any mechanical means and can be routed past the electronic module.

A further practical embodiment provides that the bus line in the region of the bus line coupling element is directly or indirectly fixed to the transceiver module or its transceiver coupling element. This connection can be of a releasable or non-releasable type. In addition to a conventional mechanical connection, e.g. a snap-on connection, this also includes a magnetic or adhesive connection, a clamped connection, or a bonded connection. In principle, any force-fitting and/or form-fitting and/or materially-bonded connection is possible. One possible design variant of a form-fitting connection is described, for example, in DE 10 2017 203 860 A1 by the applicant.

### BRIEF DESCRIPTION OF THE DRAWINGS

Advantageous aspects are explained in more detail below based on an exemplary embodiment in the drawing. In the drawings:

FIG. 1 shows a schematic illustration of a bus line having two signal lines, which comprises two surfaces in the region of a bus line coupling element that are designed for capacitive coupling as coupling parts;

FIG. 2 shows the bus line illustrated in FIG. 1, wherein insulation layers are arranged as a dielectric over the coupling parts;

FIG. 3 shows a transceiver component of an electronic module, not shown in detail, arranged on the bus line coupling element in accordance with FIG. 2;

FIG. 4 shows a schematic illustration of the arrangement of FIG. 3 in a side view; and

FIG. 5 shows schematically another exemplary embodiment in which a bus line is coupled to an electronic module by means of a snap-on device.

### DETAILED DESCRIPTION

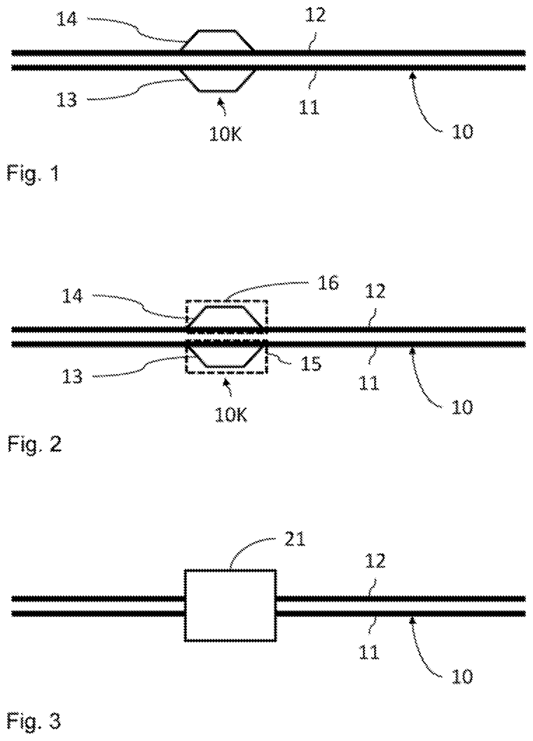

FIG. 1 shows a schematic bus line 10 in a plan view, which by way of example comprises two signal lines 11, 12 isolated from each other. Furthermore, a bus line coupling element 10K is shown, which is formed by two coupling parts 13, 14, which purely by way of example are trapezoidal in shape. The coupling parts 13, 14 in this exemplary embodiment are designed flat and provide capacitive coupling with correspondingly designed coupling parts of a transceiver coupling element, not shown in FIG. 1. The coupling parts 13, 14, which are associated with the signal lines 11, 12, are electrically isolated from each other. It is understood that the coupling part 13 comprises an electrical connection to the signal line 11 and the coupling part 14 comprises an electrical connection to the signal line 12.

The coupling parts 13, 14 are preferably mounted on a carrier made of insulating material, not shown, wherein the carrier is preferably the same size as the bus line coupling element 10K or is only slightly larger. In another embodiment, a plurality of bus line coupling elements spaced apart from each other in the longitudinal extension of the bus line 10 can also be arranged on a common carrier. In this variant, the section of the signal lines 11, 12, which run between the spaced apart bus line coupling elements 10K, can then also be arranged on this carrier.

The coupling parts 13, 14 can be made of the same material as the signal lines 11, 12, e.g. of copper, aluminum, gold or alloys of these, commonly used for signal lines. In particular, the coupling parts 13, 14 can be an integral part of the respective signal lines 11, 12, i.e. they can be produced with the signal lines 11, 12 in one processing step. The coupling parts 13, 14 can also be subsequently connected to the signal lines 11, 12 at the desired location, wherein it is then also possible to produce the coupling parts from a different material to the material of the signal lines.

FIG. 2 shows a view of the arrangement of FIG. 1, in which an insulation layer 15, 16 is applied to each coupling part 13, 14. In this exemplary embodiment, the insulation layers 15, 16 are assigned specifically to the coupling parts 13, 14. In a modified embodiment, the insulation layer 15, 16 could also be formed by a single insulation layer. For example, the material that surrounds the signal lines 11, 12 or the bus line 10 as a whole can be selected as the material of the insulation layers 15, 16. Due to the intended capacitive coupling, a high dielectric constant of the insulation material of the insulation layers 15, 16 is desired. For this reason, the insulation layers 15, 16 can be made of a different material to the insulation material of the signal lines 11, 12 or the bus line 10. As the insulation material, in principle any suitable material that meets the requirements of the required dielectric constant can be chosen. Teflon, for example, can be used as a suitable material in the automotive field.

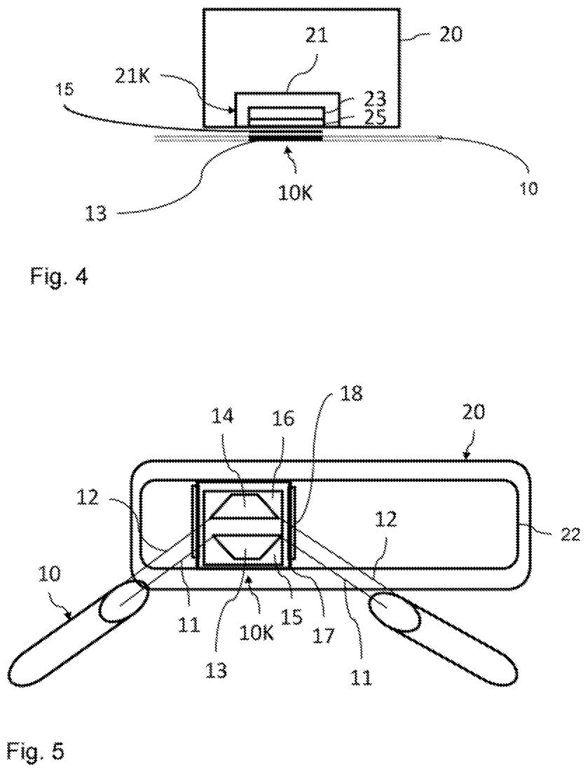

In order to be able to establish a signal transmission via a direct, but non-optical, contact-free or contactless path to an electronic module 20 (see FIG. 4), which comprises at least one transceiver component 21 with the transceiver coupling element 21K already mentioned, the bus line 10 can be coupled to the transceiver coupling element 21K in the region of the bus line coupling element 10K. A coupled state is defined here as a state in which the bus line coupling element 10K is relatively mechanically connected to the transceiver coupling element 21K. The connection can be made, for example, by means of a force-fitting and/or form-fitting and/or materially-bonded connection using appropriately provided housing elements, an adhesive, or any other type of connection. One possible design variant of a form-fitting connection is described, for example, in DE 10 2017 203 860 A1 by the applicant. The coupling can be of a releasable or non-releasable type.

FIG. 3 shows a drawing in which a transceiver component 21 is arranged on the bus line coupling element 10K, wherein the transceiver coupling element 21K with its respective coupling parts is facing the coupling parts 13, 14 of the bus line coupling element 10K. For this reason, the corresponding coupling parts of the transceiver coupling element 21K are not visible in the plan view of FIG. 3.

FIG. 4 shows a side view of the arrangement in FIG. 3, from which the described state of affairs is more clearly explained. The figure shows the signal line 10 and in the side view the coupling part 13 of the bus line coupling element 10K. Arranged above it is the insulation layer 15 associated with the coupling part 13, which is arranged at a distance from the coupling part 13 purely for the sake of the illustration. In practice, the insulation layer 15 is applied directly on the coupling part 13 without an air gap. The electronic module 20 with its transceiver component 21 is arranged above the bus line coupling element 10K of the bus line 10. The transceiver component 21 comprises the transceiver coupling element 21K with two coupling parts designed to correspond to the coupling parts 13, 14 of the bus line 10, wherein only one coupling part 23, on which an insulation layer 25 is arranged, is visible in the side view. The transceiver component 21 with the transceiver coupling element 21K is arranged in the electronic module 20 in such a way that the transceiver coupling element 21K is arranged on a boundary surface and thus directly opposite the bus line coupling element 10K. The insulation layers 15, 25 of the bus line coupling element 10K and of the transceiver coupling element 21K preferably consist of the same insulation material. Contrary to the illustration, the insulation layers 15, 25 are arranged one above the other adjacent to each other without an air gap. This results in a defined, known thickness of the dielectric layer formed from the insulation layers 15, 25, thereby forming a capacitive coupling with known electrical properties.

The shape and size of the coupling parts 13, 14 of the bus line coupling element 10K or 23, 24 of the transceiver coupling element 21K (although the coupling part 24 of the transceiver coupling element 21K associated with the coupling part 14 is not visible in the drawings) are selected with regard to their shape and size to match the prevailing transmission frequencies in the signal line and the reflection behavior on the bus line 10. In principle, the shape and size can be chosen as required, provided that the constraints of the operating frequency, the characteristic impedance of the line and a minimization of reflections are appropriately taken into account.

The signal line 10 shown in FIGS. 1 to 4 can have a plurality of bus line coupling elements 10K as described above, in order to connect a multiplicity of electronic modules 20 by means of non-optical contact-free, i.e. galvanically isolated coupling, to be able to transmit data into the bus line and receive data from the bus line. For example, this can be used in a simple way to implement an arrangement that connects a multiplicity of electronic modules 20 together in a daisy chain.

FIG. 5 shows a design variant in which the described bus line 10 is connected with its bus line coupling element 10K via a snap-on connection to an electronic module 20. The bus line is simply routed past the electronic module. For the sake of simplicity, only the coupling parts 13, 14 of the bus line coupling element 10K are visible in the schematic representation, while the coupling parts of the transceiver coupling element 21K are hidden by the bus line coupling element 10K and are therefore not shown. The snap-on connection is produced by means of corresponding housing elements 17 on the bus line coupling element 10K and 18 on the transceiver coupling element 21K. In spite of the form-fitting coupling, the bus line coupling element 10K and the transceiver coupling element 21K are non-optically coupled in a contact-free manner. The reference sign 22 indicates a contact strip of the electronic module 20.

The proposed approach can also be applied if the transceiver component and a controller of the bus line are integrated in a housing. The electronic module can be any electronic component of a vehicle, e.g. a control unit, a sensor, or an actuator.

Alternatively, the bus line can be routed past the transceiver component 21 of the electronic module by means of a so-called supply rail. An example design of such a supply rail is described in DE 10 2015 201 442 A1 by the applicant. For this purpose, the bus line proposed can replace the data lines described in the above-mentioned document. For this purpose, a multiplicity of bus lines or a bus line with an appropriate number of signal lines can be formed in a corresponding carrier or arranged on this carrier.

An alternative method of fixing the bus line coupling element 10K to the electronic module is described in DE 10 2017 203 860 A1 by the applicant, wherein here a mechanical connection is made by means of spherical connecting elements. If such spherical connecting elements are used in the region or for connecting the bus line coupling element and the transceiver coupling element, a dedicated position of the coupling parts of the bus line coupling element and transceiver coupling element is ensured in all spatial directions. In particular, this form of the connection for capacitive coupling can ensure a predetermined distance between the coupling parts of the bus line coupling element and the transceiver coupling element.

In an alternative design variant, which is not depicted in the figures, the bus line coupling element and the transceiver coupling element can also be designed for inductive coupling. In this case, the coupling parts of the two coupling elements are not formed as flat surfaces, but as flat coils which are arranged facing each other in the coupled state. The usual configuration corresponds to the previous description.

The proposed design of the coupling elements of a bus line and an electronic module results in a large number of advantages. Minimum possible dimensions in the size of the coupling elements can be implemented. The direct mounting results in minimum mechanical tolerances between the coupling elements of the bus line and the transceiver component. An exact, in particular sealed, fit in the area of the coupling elements can minimize contamination by dirt. Such an optional fit also minimizes the condensation that occurs intermittently in vehicles. Since the coupling parts are insulated and non-optical contact-free data transmission is provided by capacitive or inductive coupling, no galvanic finishing of the coupling parts is required. The aging typical of conventional plug contacts is also eliminated. Due to the small dimensions and the possibility of implementing simple shielding measures, EMC problems can be reduced.

### LIST OF REFERENCE SIGNS

10 bus line
10K bus line coupling element
11, 12 signal lines
13, 14 coupling parts
15, 16 insulation layer
17 housing element
18 housing element
20 electronic module
21K transceiver coupling element
22 contact strip
23, 24 coupling parts
25 insulation layer

1.-10. (canceled)

11. A vehicle, comprising:
a bus line having at least two signal lines and a bus line coupling element;
an electronic module comprising at least one transceiver component having a transceiver coupling element, wherein the transceiver coupling element can be coupled to the bus line coupling element in order to be able to transmit data into the bus line or receive data from the bus line in a coupled state;
wherein
the bus line coupling element and the transceiver coupling element are configured for contact-free coupling.

12. The vehicle as claimed in claim 11, wherein the bus line coupling element and the transceiver coupling element each have coupling parts corresponding in size and geometry per signal line, which are arranged facing one another and aligned towards one another in the coupled state.

13. The vehicle as claimed in claim 12, wherein the bus line coupling element and the transceiver coupling element are configured for capacitive coupling, wherein the coupling parts of the bus line coupling element and the associated coupling parts of the transceiver coupling element are coupling surfaces that in the coupled state are arranged facing each other, separated by a dielectric.

14. The vehicle as claimed in claim 13, wherein the coupling parts of the bus line coupling element and/or the coupling parts of the transceiver coupling element are surrounded by an insulation layer.

15. The vehicle as claimed in claim 14, wherein the insulation layer has a high dielectric constant.

16. The vehicle as claimed in claim 13, wherein the bus line is arranged on or in a busbar.

17. The vehicle as claimed in claim 13, wherein the bus line at least in some sections is integrated in a cable harness of the vehicle or is part of a cable harness of the vehicle.

18. The vehicle as claimed in claim 13, wherein the bus line in the region of the bus line coupling element is directly or indirectly fixed to the transceiver module or its transceiver coupling element.

19. The vehicle as claimed in claim 12, wherein the bus line coupling element and the transceiver coupling element are configured for inductive coupling, wherein the coupling parts of the bus line coupling element and the associated coupling parts of the transceiver coupling element are configured as flat coils that are arranged facing each other in the coupled state.

20. The vehicle as claimed in claim 19, wherein the coupling parts of the bus line coupling element and/or the coupling parts of the transceiver coupling element are surrounded by an insulation layer.

21. The vehicle as claimed in claim 19, wherein the bus line is arranged on or in a busbar.

22. The vehicle as claimed in claim 19, wherein the bus line at least in some sections is integrated in a cable harness of the vehicle or is part of a cable harness of the vehicle.

23. The vehicle as claimed in claim 19, wherein the bus line in the region of the bus line coupling element is directly or indirectly fixed to the transceiver module or its transceiver coupling element.

24. The vehicle as claimed in claim 12, wherein the coupling parts of the bus line coupling element are integral components of the signal lines.

25. The vehicle as claimed in claim 12, wherein the coupling parts of the bus line coupling element and/or the coupling parts of the transceiver coupling element are surrounded by an insulation layer.

26. The vehicle as claimed in claim 25, wherein the insulation layer has a high dielectric constant.

27. The vehicle as claimed in claim 11, wherein the bus line is arranged on or in a carrier.

28. The vehicle as claimed in claim 27, wherein the bus line is arranged on or in a busbar.

29. The vehicle as claimed in claim 11, wherein the bus line at least in some sections is integrated in a cable harness of the vehicle or is part of a cable harness of the vehicle.

30. The vehicle as claimed in claim 11, wherein the bus line in the region of the bus line coupling element is directly or indirectly fixed to the transceiver module or its transceiver coupling element.
